(19) United States
(12) Patent Application Publication
(10) Pub. No.: US 2026/0159031 A1
(43) Pub. Date: Jun. 11, 2026

(54) DIGITAL KEY MANAGEMENT SYSTEM

(71) Applicant: GM GLOBAL TECHNOLOGY OPERATIONS LLC, Detroit, MI (US)

(72) Inventors: Mohamed A. Layouni, Fraser, MI (US); Ahmed F. Al Alawy, Canton, MI (US); Venkata Naga Siva Vikas Vemuri, Farmington Hills, MI (US)

(73) Assignee: GM GLOBAL TECHNOLOGY OPERATIONS LLC, Detroit, MI (US)

(21) Appl. No.: 18/976,977

(22) Filed: Dec. 11, 2024

(51) Int. Cl. B60R 25/24

(52) U.S. Cl. CPC B60R 25/241; B60R 2325/205

(57) ABSTRACT

A method for revoking access of a digital key to a vehicle includes providing a first key access revocation request to a computer server of a manufacturer of the vehicle. The method additionally includes providing, by the computer server of the manufacturer of the vehicle, a second key access revocation request to the vehicle. Additionally, the method includes in response to the second key access revocation request, revoking, through one or more controllers in the vehicle, the digital key. Further, the method involves, after revocation of the digital key, informing a key tracking server that the digital key has been revoked. Further still, the method includes after informing the key tracking server that the digital key has been revoked, removing the digital key from electronic key media on which the digital key resides.

### INTRODUCTION

This disclosure is in the field of digital key management systems.

Digital keys may be used for access to a vehicle. In some cases, that access may be intended to be temporary for specific users, rather than the permanent access that may be held by the owner of the vehicle.

A digital key may be programmed onto an electronic key medium, such as a keycard or a hardware token. In the event that the digital key is intended to be temporary, a method for revoking access of the digital key from the vehicle, even if the electronic key medium has been lost or stolen or is nonfunctional and cannot therefore participate in the revocation process, may prove advantageous.

### SUMMARY

A method for revoking access of a digital key to a vehicle includes providing a first key access revocation request to a computer server of a manufacturer of the vehicle. The method additionally includes providing, by the computer server of the manufacturer of the vehicle, a second key access revocation request to the vehicle. Additionally, the method includes in response to the second key access revocation request, revoking, through one or more controllers in the vehicle, the digital key. Further, the method involves, after revocation of the digital key, informing a key tracking server that the digital key has been revoked. Further still, the method includes after informing the key tracking server that the digital key has been revoked, removing the digital key from electronic key media on which the digital key resides.

The first key access revocation request may be provided by a factory in which the vehicle was built, with the first key access revocation request provided by a message signed by the factory. The first key access revocation request may be signed with a public key of the factory. The second key access revocation request may be provided by a message signed by the computer server of the manufacture of the vehicle. Informing the key tracking server that the digital key has been revoked may be done with a message signed by the computer server of the manufacturer of the vehicle.

The method may further include, by the key tracking server, confirming revocation of the digital key via a message to the computer server of the manufacturer of the vehicle signed with a signature of the key tracking server. The method may additionally include by the computer server of the vehicle manufacturer, confirming revocation of the digital key via a message to the factory signed with the signature of the key tracking server.

A second method for revoking access of a digital key to a vehicle, the method includes, through a human-machine interface in the vehicle, receiving a request for revocation of the digital key. The method also includes confirming the request via an electronic device of a user. Further, the method includes revoking, through one or more controllers in the vehicle, access of the digital key to the vehicle. Additionally, the method involves confirming, to a computer server of a manufacturer of the vehicle, revocation of access of the digital key to the vehicle. Also, the method includes confirming, to a key tracking server, revocation of access of the digital key to the vehicle. Further yet, the method includes, after revocation of access of the digital key to the vehicle, removing the digital key from an electronic key medium on which the digital key resides.

In the second method, the electronic device may be a mobile phone. The method may further include validating the revocation request via a wallet in the mobile phone. Confirming, to the computer server of the manufacturer of the vehicle, revocation of access of the digital key to the vehicle may be done via a message signed with a public key of the vehicle.

A third method for revoking access of a digital key to one or more vehicles of a vehicle fleet includes providing a first key access revocation request to a computer server of an entity that manages the vehicle fleet. The method additionally involves, by the computer server of the entity, providing a second key access revocation request to a second computer server of a manufacturer of the one or more vehicles. Further, the method includes, by the second computer server of the manufacturer of the one or more vehicles, providing a third key access revocation request to the one or more vehicles. Also, the method includes revoking access of the digital key to the one or more vehicles. Further yet, the method includes confirming, to a key tracking server, revocation of access of the digital key to the one or more vehicles. Additionally, the method involves, after revoking access of the digital key to the one or more vehicles, removing the digital key from an electronic key medium on which the digital key resides.

In the third method, the first key access revocation request may be provided by an employee of the entity. Further, the second key access revocation request may be provided by a message signed with a public key of the entity. Additionally, the third key access revocation request may be provided by a message signed by the second computer server. Further yet, confirmation to the key tracking server of revocation of access of the digital key to the one or more vehicles may be done via a message signed by the second server.

The third method may include confirming to the computer server of the entity, by the second server via a message signed with a public key certificate of the key tracking server, revocation of access of the digital key to the one or more vehicles. The method may also include confirming to the employee, by the computer server of the entity, revocation of access of the digital key to the one or more vehicles. Removing the digital key from the electronic key medium on which the digital key resides may be performed by short-range wireless communication with the electronic key medium.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 illustrates a system for managing digital keys of vehicles.

FIG. 2 illustrates a method for revoking access of a digital key to vehicles.

FIG. 3 illustrates a second method for revoking access of digital keys to vehicles.

FIG. 4 illustrates a second system for managing digital keys of vehicles.

FIG. 5 illustrates a third method for revoking access of digital keys to vehicles.

### DETAILED DESCRIPTION

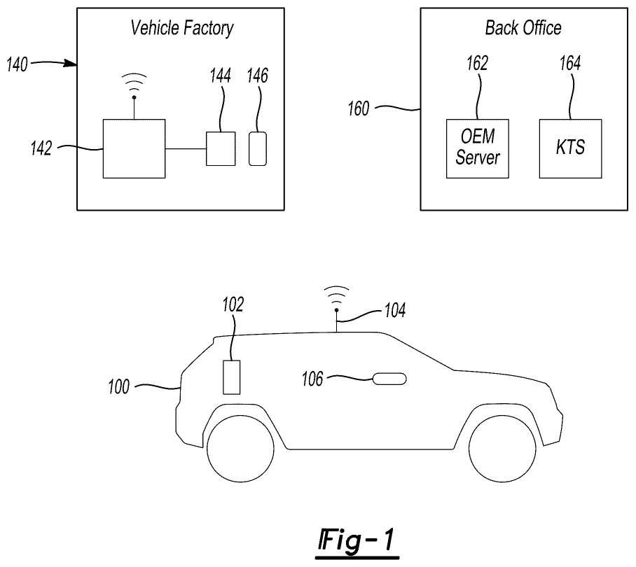

Refer first to FIG. 1, where a vehicle 100 is illustrated. Vehicle 100 may be any type or style of vehicle, such as a car, truck, sport-utility vehicle, van, motorcycle, scooter, boat, or aircraft. Vehicle 100 may contain an electronic controller 102. Electronic controller 102 may be a telematics control unit (“TCU”), which manages cellular communications to and from vehicle 100 via an antenna 104. Electronic controller 102 may also control access by a digital key to vehicle 100. “Access” in this case may mean controlling locking and/or unlocking doors of vehicle 100, allowing and/or disallowing starting of vehicle 100, and arming and/or disarming of a security alarm system in vehicle 100.

The digital key may comply with the digital key standard of the so-called Car Connectivity Consortium (“CCC”). The digital key may be programmed onto an electronic key medium such as a key card or a higher-function hardware token. A hardware token may be a self-powered device. The electronic key medium may have short-range wireless communication capability, such as one or more of near-field communication (“NFC”), Bluetooth® Low Energy (“BLE”) or ultrawideband radar (“UWB”). A hardware token may be able to support each of NFC, BLE, and UWB. Through the short-range wireless communication capability, the digital key may access to vehicle 100. Also through the short-range wireless communication capability, the digital key may be programmed onto and deprogrammed/deleted from the electronic key medium on which the digital key resides.

Electronic controller 102 may be a microprocessor-based controller that should be understood to include appropriate microcomputer resources (e.g., microcontroller, memory, software, inputs, outputs, peripherals, and the like) to perform the functions ascribed to electronic controller 102 herein. The functions of electronic controller 102 may also be shared by one or more additional electronic controllers that may be networked together and therefore able to share data and computing responsibility.

Electronic controller 102 may be responsive to and may execute instructions, each of which may comprise one or more software commands. Each instruction may further comprise one or more additional instructions.

Vehicle 100 may also include a human-machine interface (“HMI”) 106. HMI 106 may contain switches, a visual display, and an audible sound generator, through which a user of vehicle 100 may receive information, input various commands, and receive visual and/or audible feedback from such commands. HMI 106 may, for instance, include an instrument panel display or a driver information center display and associated switches or buttons for inputting commands.

FIG. 1 also illustrates a factory 140 in which vehicle 100 may have been assembled/manufactured. Factory 140 may be operated by or on behalf of the original-equipment manufacturer (“OEM”) who assembled/manufactured vehicle 100 or by or on behalf of whom vehicle 100 was assembled/manufactured. Such OEM may be, for instance, General Motors Company or a similarly-situated entity. In or associated with factory 140 may be a computer 142, such as a laptop computer, which may be operated by a worker working in factory 140. Connected to computer 142 may be a key programming terminal 144. Key programming terminal 144 may act upon appropriate commands issued by computer 142 to program a digital key onto or deprogram a digital key from an electronic key medium 146 by, for instance, short-range wireless communication. Electronic key medium 146 may be, for instance, an electronic key card or a digital token. Electronic key medium 146 may be programmed with a digital key that permits electronic key medium 146 to have access to vehicle 100. Such programming may be intended to be temporary, so that vehicle 100 may, for instance, be accessed by employees working in factory 140. Such access may be so that vehicle 100 can undergo final testing in factory 140, may be driven on the grounds of factory 140, or may be loaded onto or taken off a transport vehicle used to transport vehicle 100 from factory 140 to the final delivery destination for vehicle 100. Because the programming of electronic key medium 146 with a digital key for vehicle 100 may be intended to be non-permanent in such a case, an effective way to deprogram the digital key from vehicle 100 will be desirable. Such deprogramming without actually being in possession of electronic key medium 146, or if electronic key medium 146 is damaged or otherwise inoperable, may be particularly desirable.

It may be noted that computer 142 may also be a mobile phone that contains a short-range wireless communication interface therein. As such, computer 142 and the mobile phone may be integrated, rather than computer 142 and key programming terminal 144 being separate devices.

FIG. 1 further illustrates an OEM back office 160. OEM back office 160 may be operated by or on behalf of the OEM of vehicle 100. OEM back office 160 may include an OEM server 162. OEM server 162 may be a computer server operated by or on behalf of the OEM of vehicle 100. Communication from OEM server 162 may be trusted by vehicle 100 not to be malicious or otherwise untrustworthy. Responsibilities of OEM server 162 may include generating digital keys and managing which digital keys, which may include the digital key programmed onto electronic key medium 146, have access to vehicle 100. OEM server 162 should be understood to have appropriate computer resources, including communication resources such as internet access, in order to perform the functions ascribed to OEM server 162 herein. Such communication resources include access to wireless communication capability in order to wirelessly communicate with vehicle 100. Communication by OEM server 162 may be trusted by vehicle 100, such as by messages from OEM server 162 to vehicle 100 being signed by OEM server 162 with a digital certificate recognized and accepted by controller 102 in vehicle 100 for security and verification purposes.

OEM back office 160 may also include a key tracking server (“KTS”) 164. KTS may be a computer server operated by or on behalf of the OEM of vehicle 100 or by a third party. KTS 164 may have responsibility to track, for recordkeeping purposes, which digital keys, such as a digital key programmed onto electronic key medium 146, have access to vehicles manufactured by the OEM, including vehicle 100. KTS 164 may also track when and by whom digital keys have been given access to vehicle 100 and when and by whom access by digital keys to vehicle 100 has been revoked.

KTS 164 may also be physically located elsewhere than the physical location of OEM server 162. KTS 164 may also be operated by or on behalf of an entity other than the OEM of vehicle 100, such as by a regulatory or law enforcement body. KTS 164 may also be embodied in the same computer server as OEM server 162. In any event, OEM server 162 and KTS 164 may be in communication with one another.

As noted, a digital key programmed onto electronic key medium 146 may be intended to have only temporary access to vehicle 100, such as in connection with the manufacturing and/or transport of vehicle 100. As such, a process for revoking access of the digital key to vehicle 100 and removing the digital key from electronic key medium 146 may be appropriate.

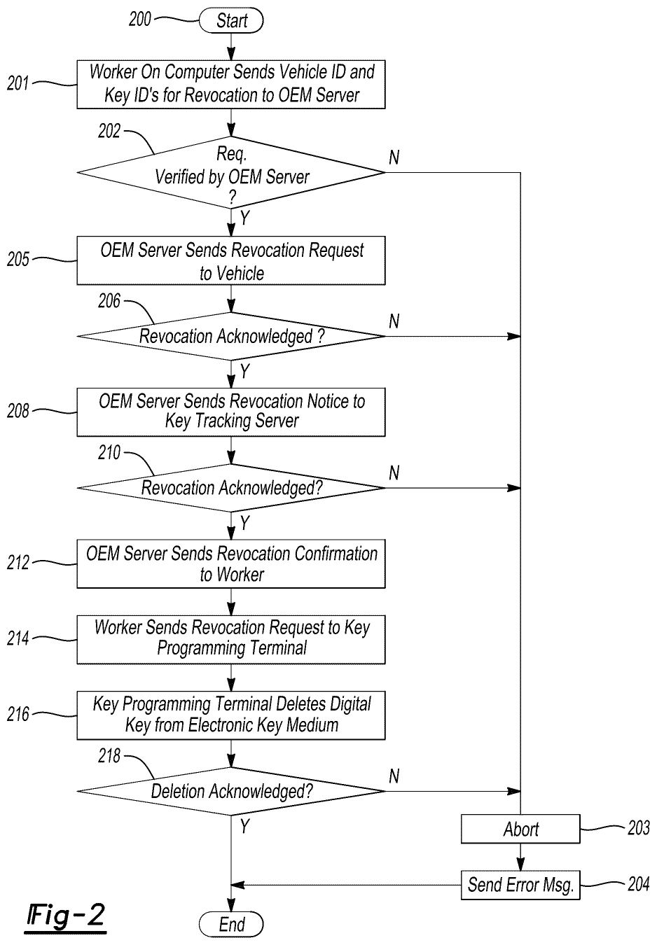

Refer now to FIG. 2, where a method for revoking access of a digital key to a vehicle such as vehicle 100 and removing/deprogramming/deleting the digital key from a key medium such as electronic key medium 146 is illustrated. The process starts at block 200. Then at block 201, a worker on computer 142 may select a vehicle identifier (such as an identifier for vehicle 100) and a key identifier for the specific digital key whose access to vehicle 100 is to be revoked. Note that multiple digital keys on multiple digital key media may have been given access to vehicle 100, for the convenience of workers in factory 140. Therefore, multiple digital key identifiers may alternatively be selected for revocation of access to vehicle 100. (In a variation, multiple key identifiers may be selected for revocation of access to multiple vehicles to which they have been provided access.) A revocation request may be sent to OEM server 162. That request may be via a message that may be signed with a public key of factory 140 for security and verification purposes. At block 202, OEM server 162 may verify that OEM server 162 understands the revocation request to be a valid request by examining the signature on the message. If OEM server 162 does not conclude that it can trust the revocation request, the routine may abort (block 203) and/or an appropriate error message be generated (block 204), which error message may be returned to the worker.

At block 205, OEM server 162 may send a revocation request to vehicle 100. The revocation request may include the digital key identifier of the digital key to be revoked and the vehicle identifier. The revocation request may be sent in a message signed by OEM server 162 for security and verification purposes.

At block 206, controller 102 confirms that it understands the revocation request to be valid, acts to revoke the digital key from access to vehicle 100 and, if the revocation is successful, acknowledges the successful revocation by a message to OEM server 162. The message may be signed by vehicle 100 for security and verification purposes. On the other hand, if vehicle 100 is not able to confirm the authentication of the revocation message sent by OEM server 162 or vehicle 100 is not able to successfully revoke the digital key, then vehicle 100 may send a nonacknowledgement message to OEM server 162 and the revocation process may abort (block 203) and/or an error message generated (block 204).

At block 208, OEM server 162 may send a revocation notice to KTS 164. The revocation notice may contain the identification of vehicle 100 and the identification of the digital key(s) whose revocation from access to vehicle 100 is to be recorded or reflected in KTS 164. The revocation notice may be via a message signed by OEM server 162 for security and verification purposes.

At block 210, KTS 164 may verify that KTS 164 understands the revocation notice to be valid and proceed to reflect revocation of the digital key from access to vehicle 100 in KTS 164. If the revocation notice has been verified and the revocation successfully reflected in KTS 164, the process may proceed to block 212. If not, the process may be aborted (block 203) and/or an error message may be sent (block 204).

At block 212, OEM server 162 may send revocation confirmation to the worker at factory 140 who originally requested the revocation. That confirmation may be via an acknowledgement message that contains a transaction identification number and may bear the signature of KTS 164 for security and verification.

At this point, access of the digital key(s) to vehicle 100 has been revoked and that revocation reflected in KTS 164, even if the respective electronic key medium/media has/have been lost or damaged. That is, the electronic key medium/media have not been needed to participate in revocation of the digital key(s) from having access to vehicle 100.

If electronic key medium 146 is in fact available and operational, the process may proceed to block 214. There, the worker in factory 140 may, via computer 142, send a revocation request to key programming terminal 144. That request may be via a message that contains the digital key identifier of the digital key and may be signed with the public key of factory 140 for security and verification.

Key programming terminal 144 may thereafter, at block 216, remove/delete the digital key from the electronic key medium 146. This may be performed by short-range wireless communication between key programming terminal 144 and electronic key medium 146. Such short-range communication may be, for instance, near-field communication (“NFC”), Bluetooth® Low Energy (“BLE”), or ultra-wide band radar (“UWB”). The electronic key medium, such as electronic key medium 146, may respond to key programming terminal 144 at block 218 with a message acknowledging or not acknowledging successful removal of the digital key from the electronic key medium. If the digital key has been successfully removed from the electronic key medium, a digital key “slot” on electronic key medium 146 has been freed up so that another digital key, say, for vehicle 100 or for a different vehicle, may thereafter be programmed onto that “slot”. An electronic key medium such as electronic key medium 146 may have a finite number of “slots” onto which digital keys may be programmed, so removal of unused digital keys from an electronic key medium may be desirable. Removal of unused digital keys from a vehicle such as vehicle 100 may also be desirable, given finite memory in controller 102 for accommodating digital keys that have been given access to vehicle 100.

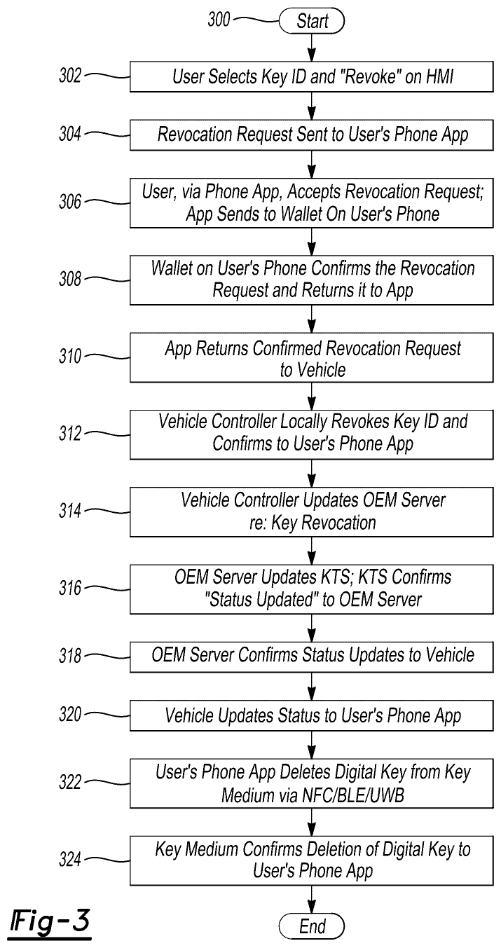

Refer now to FIG. 3. Illustrated there is a key revocation method that may be executed from HMI 106 in vehicle 100. The method starts at block 300. At block 302, a user, such as the owner of vehicle 100, selects a digital key identifier from a menu on the HMI and selects “revoke”. Controller 102 then, at block 304, sends a revocation request to the user's phone for two-factor authentication confirmation of the revocation request by an app on the user's phone. At block 306, the user accepts the revocation request via the app on the user's phone, from which the revocation request is sent to a wallet, also on the user's phone. At block 308, the wallet on the user's phone signs the revocation request with a digital key of the user/owner and returns the signed revocation request to the app on the user's phone. At block 310, the app on the user's phone returns the confirmed revocation request (comprising the original revocation request and the signature from the wallet) to controller 102 in vehicle 100. At block 312, then, controller 102 locally revokes access of the digital key to vehicle 100 and confirms the revocation to the user's phone app via an acknowledgment message signed by the public key certificate of vehicle 100. In the absence of this acknowledgement message or if the user's phone app does not trust the signature on the acknowledgement message, an error message may be generated. Additionally, the routine may abort, and the routine exited; alternatively, the routine may instead abort at a later stage if an error is generated, such as if a final confirmation from the OEM server 162 and/or the KTS 164 is never received by the user. At that point, it is clear that the revocation process was not successful.

The wallet may be a dedicated security peripheral embedded in the user's phone. It may provide secure storage and a secure execution environment to perform cybersecurity functions like the generation and verification of signatures and Message Authentication Codes (MACs), encryption, decryption, and other cryptographic and cybersecurity-sensitive functions.

At block 314, controller 102 may update OEM server 162 about the revocation of the digital key. This update may be via a status message that contains the digital key identifier and its now-revoked status, signed by the public key certificate of vehicle 100 for security and verification. The message may also contain the owner's revocation request, signed by the owner, such as with the owner's public key certificate. If OEM server 162 concludes that it can trust the foregoing messages, OEM server 162 at block 316 updates key tracking server 164 about the now-revoked status of the digital key, via a message signed by the public key certificate of OEM server 162. Also at block 316, key tracking server 164 confirms that key tracking server now reflects the revoked status of the digital key. This may be done via a message from key tracking server 164 to OEM server 162 signed by the public key certificate of key tracking server 164 for security and verification.

At block 318, OEM server 162 may confirm the status of key tracking server 164 to controller 102 in vehicle 100 via a message signed by the public key certificate of key tracking server 164. If controller 102 does not conclude that it can trust the signature on the message or if no message is received, the routine may abort and/or an error message generated. If, however, controller 102 receives the message and concludes that it can trust the signature on the message, the routine proceeds to block 320.

At block 320, controller 102 updates the app on the user's phone to inform the user via the user's phone app that key tracking server 164 now reflects the deleted status of the digital key. This update may be via a message signed with the key tracking server's public key certificate. If the user's phone app does not conclude that it can trust the signature on the message or if no message is received, the routine may abort and/or an error message generated.

At this point, the digital key has been revoked from access to vehicle 100 and OEM server 162 and key tracking server 164 reflect this revocation. Notably, the revocation has occurred without involvement of the digital key itself, a significant advantage if the electronic key medium has been lost or is inoperative.

At block 322, the user's phone app removes the digital key material of the revoked digital key from the electronic key medium. The phone physically performs that removal via short-range wireless communication that may be available on the phone, such as NFC, BLE, or UWB, under the supervision of the app on the user's phone. The removal of the digital key may be acknowledged by the electronic key medium via a message from the electronic key medium to the app on the user's phone (block 324). The acknowledgement may be via a message signed, say, by the trusted public key certificate of the electronic key medium. If no message is received by the app on the user's phone or if the app does not conclude that it can trust the message, an error message may be generated via the app on the phone for the user.

As an alternative to the method illustrated in FIG. 3, the digital key revocation may originate from the user/owner of vehicle 100 making the request not on HMI 106 but via the app on the user/owner's phone. The app may then message controller 102 in vehicle 100 to revoke access of the digital key to vehicle 100 and otherwise follow the process in FIG. 3.

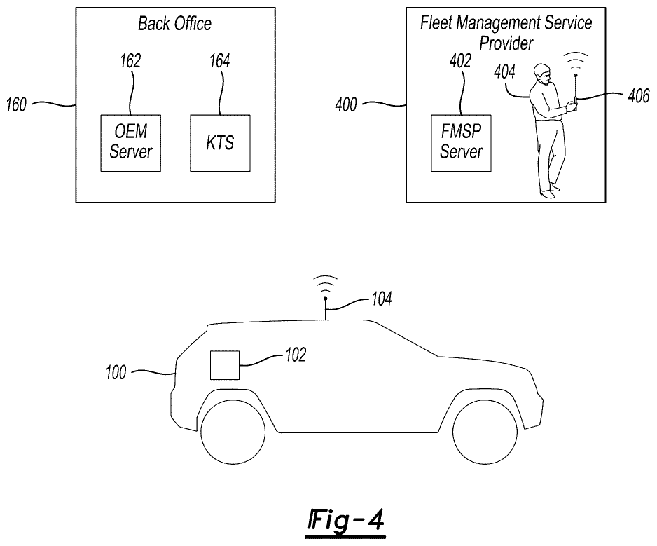

Refer now additionally to FIG. 4. There, in addition to vehicle 100 and OEM back office 160, the facility 400 of a fleet management service provider is illustrated. The fleet management service provider may provide management services to the owner or operator of a fleet of vehicles. The owner or operator of a fleet of vehicles may be a car or truck rental company, for instance. The owner or operator of the fleet of vehicle may, as another example, be a transportation logistics company. The fleet management service provider may be the owner or operator of the vehicle fleet. The fleet management service provider may alternatively be a company or entity that is contracted by the owner or operator of the vehicle fleet to help manage the vehicle fleet.

Facility 400 may contain or be associated with a fleet management service provider (“FMSP”) server 402. A worker 404 may be associated with the fleet management service provider. Worker 404 may have a cellular phone 406 such as a smartphone. Alternatively, worker 404 may work at a computer, such as a desktop or laptop computer.

A digital key may have access to one or more vehicles 100 that are managed by the fleet management service provider. Access of the digital key to those vehicle(s) may be intended to be temporary; for example, the digital key may be issued to a driver employed by the owner or operator of the vehicle fleet or to a worker employed by the owner or operator of the vehicle fleet to service/maintain the vehicles in the vehicle fleet. It may be desired to revoke access of the digital key to the vehicle(s) upon the end of employment of the driver or worker.

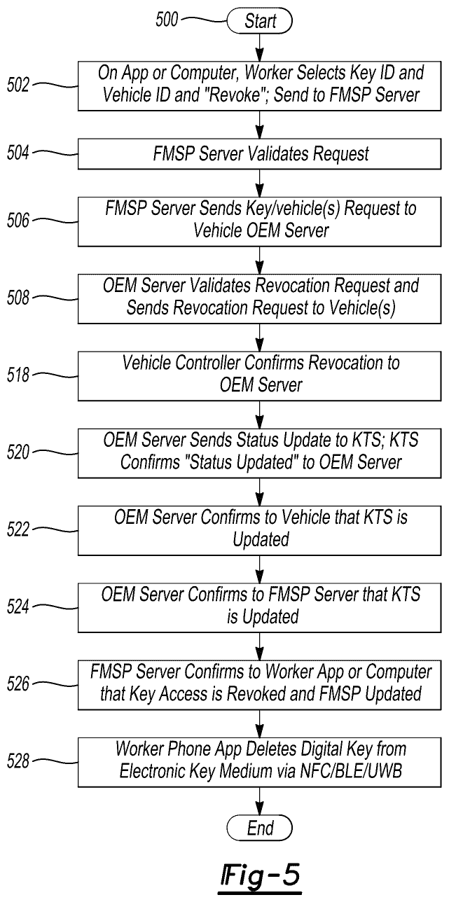

Refer now additionally to FIG. 5, where a method for revoking access of a digital key is described. The method starts at block 500. At block 502, worker 404 may send a revocation request for a digital key to FMSP server 402. Worker 404 may be an employee (full-time, part-time, permanent, temporary, working under contract, hourly, salaried or otherwise) of or otherwise working for the fleet management service provider. That revocation request may include the identification of the digital key and the identification of vehicle 100, access to which worker 404 is seeking to revoke. Alternatively, if worker 404 is seeking to revoke access of the digital key to all vehicles to which the digital key has access, the revocation request may include only the identification of the digital key and not identification of any specific vehicle. The revocation request may be sent via a message to FMSP server 402 that is signed with the fleet management service provider worker's public key certificate. The public key certificate may be signed by the fleet owner's public key certificate that is known to and trusted by OEM server 162.

At block 504, FMSP server 402 validates the signature on the revocation request message to confirm that FMSP server 402 trusts the revocation request to be valid. If FMSP server 402 does not trust the revocation request to be valid, the process may abort and/or an error message logged and/or generated and returned to worker 404. If FMSP server 402 trusts the revocation request to be valid and no specific vehicle is identified in the request, then FMSP server 402 determines the list of vehicles to which the digital key has access, which is recorded in FMSP server 402.

At block 506, FMSP server 402 sends a revocation request to OEM server 162. The revocation request may include the digital key identifier and the list of vehicles to which the digital key has access. The revocation request may be via a message that is signed with the FMSP's public key certificate for security and verification.

At block 508, OEM server 162 determines whether it believes the revocation request to be valid by confirming the signature on the revocation request message. If OEM server 162 does not believe it can trust the revocation request, the process may abort and/or an error logged and/or an error message returned to worker 404. Otherwise, OEM server 162 sends the revocation request to controller 102 of vehicle 100. The revocation request may be via a message signed with the certificate of OEM server 162.

At block 518, controller 102 determines whether it trusts the revocation message from OEM server 162 by checking the signature with which the message is signed. If controller 102 does not trust the revocation message or if controller 102 is unable to revoke access of the digital key to vehicle 100, controller 102 may send a nonacknowledgment message to OEM server 162, the revocation process may abort, and/or an error may be logged and/or an error message returned to worker 404. Otherwise, controller 102 may revoke access of the digital key to vehicle 100 and return an acknowledgment message, signed with the public key certificate of vehicle 100, to OEM server 162.

At block 520, OEM server 162 may send to KTS 164 a status message regarding the revocation of access of the digital key to vehicle 100. That message may be signed by the public key certificate of OEM server 162 for security and verification. The message may also be signed with the public key certificate of vehicle 100, to confirm that vehicle 100 also confirms that the revocation has occurred. KTS 164 may verify that the status message is trustworthy by checking its signature(s) and then proceed to update KTS 164 to reflect revocation of access of the digital key to vehicle 100. If KTS 164 does not trust the status message or is unable to update KTS 164, the process may abort and/or an error message returned. If KTS 164 is successful in updating the status, it may return a “status updated” message to OEM server 162. The “status updated” message may be signed by the public key certificate of KTS 164 for security and verification.

At block 522, OEM server 162 may send a confirmation message to controller 102 that the status in KTS 164 has been updated. That message may be signed, such as with the public key certificate of KTS 164, for security and verification. At block 524, OEM server 162 may also send a confirmation message to FMSP server 402 that the revocation status of the digital key has been updated in KTS 164. That message may be signed, such as with the public key certificate of KTS 164, for security and verification.

At block 526, FMSP server 402 may send a confirmation message to worker 404 via the app on phone 406 or via the computer on which worker 404 is working that the digital key's access to vehicle 100 have been revoked and the revocation status of the digital key has been updated in KTS 164. That message may be signed with the public key certificate of KTS 164 for security and verification.

At this point, access of the digital key to vehicle 100 has been revoked. The digital key has not participated in the process, and as such, the process does not depend upon the digital key being present or upon the electronic key medium being functional for revocation of access of the digital key to vehicle 100.

At block 528, then, the digital key may be deleted or deprogrammed from the electronic key medium on which the digital key resides. Phone 406 of worker 404 may connect to the electronic key medium via a short-range wireless communication interface that may be present on phone 406. The short-range wireless communication may be via NFC, BLE, UWB, or other suitable short-range wireless communication interfaces. Via the app on phone 406, worker 404 may issue a command to the electronic key medium for deletion, removal, or deprogramming of the digital key from the electronic key medium. Upon successful deletion, the electronic key medium may send a message acknowledging the deletion via the app on phone 406 to worker 404. That message may be signed, say, by the trusted public key certificate of the electronic key medium.

As an alternative, if worker 404 is working at a computer, such as a laptop or desktop computer, worker 404 may delete the digital key from the electronic key medium via a key programming terminal, such as key programming terminal 144 (FIG. 1) connected to the computer.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

What is claimed is:

1. A method for revoking access of a digital key to a vehicle, the method comprising:
providing a first key access revocation request to a computer server of a manufacturer of the vehicle;
providing, by the computer server of the manufacturer of the vehicle, a second key access revocation request to the vehicle;
in response to the second key access revocation request, revoking, through one or more controllers in the vehicle, access of the digital key to the vehicle;
after revocation of access of the digital key to the vehicle, informing a key tracking server that access of the digital key to the vehicle has been revoked; and
after informing the key tracking server that access of the digital key to the vehicle has been revoked, removing the digital key from electronic key media on which the digital key resides.

2. The method of claim 1, wherein:
the first key access revocation request is provided by a factory in which the vehicle was built; and
the first key access revocation request is provided by a message signed by the factory.

3. The method of claim 2, wherein the first key access revocation request is signed with a public key of the factory.

4. The method of claim 2, wherein the second key access revocation request is provided by a message signed by the computer server of the manufacturer of the vehicle.

5. The method of claim 4, wherein informing the key tracking server that access of the digital key to the vehicle has been revoked is done with a message signed by the computer server of the manufacturer of the vehicle.

6. The method of claim 5, further comprising:
by the key tracking server, confirming revocation of access of the digital key to the vehicle via a message to the computer server of the manufacturer of the vehicle signed with a signature of the key tracking server.

7. The method of claim 6, further comprising:
by the computer server of the manufacturer of the vehicle, confirming revocation of access of the digital key to the vehicle via a message to the factory signed with the signature of the key tracking server.

8. The method of claim 1, wherein removing the one or more digital keys from electronic key media on which the one or more digital keys reside is performed via short-range wireless communication between a key programming terminal and the electronic key media on which the digital key resides.

9. A method for revoking access of a digital key to a vehicle, the method comprising:
through a human-machine interface in the vehicle, receiving a request for revocation of access of the digital key to the vehicle;
confirming the request via an electronic device of a user;
revoking, through one or more controllers in the vehicle, access of the digital key to the vehicle;
confirming, to a computer server of a manufacturer of the vehicle, revocation of access of the digital key to the vehicle;
confirming, to a key tracking server, revocation of access of the digital key to the vehicle; and
after revocation of access of the digital key to the vehicle, removing the digital key from an electronic key medium on which the digital key resides.

10. The method of claim 9, wherein the electronic device is a mobile phone.

11. The method of claim 10, further comprising validating the request for revocation via a wallet in the mobile phone.

12. The method of claim 11, wherein confirming, to the computer server of the manufacturer of the vehicle, revocation of access of the digital key to the vehicle is done via a message signed with a public key of the vehicle.

13. A method for revoking access of a digital key to one or more vehicles of a vehicle fleet, the method comprising:
providing a first key access revocation request to a computer server of an entity that manages the vehicle fleet;
by the computer server of the entity, providing a second key access revocation request to a second computer server of a manufacturer of the one or more vehicles;
by the second computer server, providing a third key access revocation request to the one or more vehicles;
revoking access of the digital key to the one or more vehicles;
confirming, to a key tracking server, revocation of access of the digital key to the one or more vehicles; and
after revoking access of the digital key to the one or more vehicles, removing the digital key from an electronic key medium on which the digital key resides.

14. The method of claim 13, wherein the first key access revocation request is provided by an employee of the entity.

15. The method of claim 14, wherein the second key access revocation request is provided by a message signed with a public key certificate of the entity.

16. The method of claim 15, wherein the third key access revocation request is provided by a message signed by the second computer server.

17. The method of claim 16, wherein confirmation to the key tracking server of revocation of access of the digital key to the one or more vehicles is done via a message signed by the second computer server.

18. The method of claim 17, further comprising confirming to the computer server of the entity, by the second computer server via a message signed with a public key certificate of the key tracking server, revocation of access of the digital key to the one or more vehicles.

19. The method of claim 18, further comprising confirming to the employee, by the computer server of the entity, revocation of access of the digital key to the one or more vehicles.

20. The method of claim 19, wherein removing the digital key from the electronic key medium on which the digital key resides is performed by short-range wireless communication with the electronic key medium.
